(19) United States
(12) Patent Application Publication
(10) Pub. No.: US 2013/0272341 A1
(43) Pub. Date: Oct. 17, 2013

(54) TEMPERATURE SENSOR AND TEMPERATURE MEASUREMENT METHOD THEREOF

(71) Applicant: KOREA ADVANCED INSTITUTE OF SCIENCE AND TECHNOLOGY, (US)

(72) Inventors: Sang Gug LEE, Daejeon (KR); Ohyong JUNG, Daejeon (KR); Seungjin KIM, Daejeon (KR); Seok Kyun HAN, Daejeon (KR)

(73) Assignee: KOREA ADVANCED INSTITUTE OF SCIENCE AND TECHNOLOGY, Daejeon (KR)

(21) Appl. No.: 13/753,650

(22) Filed: Jan. 30, 2013

(30) Foreign Application Priority Data
Apr. 13, 2012 (KR) 10-2012-0038608

(51) Int. Cl. G01K 7/34

(52) U.S. Cl. CPC G01K 7/34
USPC 374/184

(57) ABSTRACT

A temperature sensor that senses a temperature on the basis of a relaxation oscillator, includes: a bias circuit unit that outputs a bias current increasing with an increase in temperature; a capacitor voltage unit that charges a capacitor with the bias current and discharges the current when receiving a control signal; a pulse generating unit that outputs a pulse when the voltage of the capacitor is higher than a reference voltage, changes the pulse width of the pulse, and transmits the pulse corresponding to the control signal to the capacitor voltage unit; and a counter unit that counts and outputs, as a digital value, the number of pulses outputted from the pulse generating unit, on the basis of a reference frequency.

### CROSS-REFERENCE TO RELATED APPLICATION

This application claims priority to and the benefit of Korean Patent Application No. 10-2012-0038608 filed in the Korean Intellectual Property Office on Apr. 13, 2012, the entire contents of which are incorporated herein by reference.

### BACKGROUND

(a) Field

The present invention relates to a temperature sensor and a temperature measurement method thereof.

(b) Description of the Related Art

Temperature sensors that generate digital output can be implemented in various ways. Recently, temperature sensors are used by an application for RFID and a study of a temperature sensor that consumes less power has been conducted. The temperature sensors developed up to now output a change in voltage or current, which increases in proportion to a temperature, to an analog-digital converter.

The temperature sensors developed up to now have been widely used, because they can achieve high performance by means of many compensation plans, but the entire performance depends on an ADC and a high-performance ADC is not suitable for low-power design. Further, the temperature sensor may show undesired linearity. Therefore, a demand for a temperature that ensures linearity and operates with low power on the rise at present.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a temperature sensor having advantages of reducing power consumption by using a relaxation oscillator and a counter, and of increasing linearity in temperature-frequency conversion by adjusting the inclination of a current-frequency graph.

According to an embodiment of the present invention, a temperature sensor that senses a temperature on the basis of a relaxation oscillator, includes: a bias circuit unit that outputs a bias current increasing with an increase in temperature; a capacitor voltage unit that charges a capacitor with the bias current and discharges the current when receiving a control signal; a pulse generating unit that outputs a pulse when the voltage of the capacitor is higher than a reference voltage, changes the pulse width of the pulse, and transmits the pulse corresponding to the control signal to the capacitor voltage unit; and a counter unit that counts and outputs, as a digital value, the number of pulses outputted from the pulse generating unit, on the basis of a reference frequency.

The pulse generating unit may include at least one inverter and a capacitor connected with the inverter in series, and change the pulse width by adjusting the amount of a current flowing through the inverter.

The pulse generating unit may compensate for nonlinearity of the bias current to a temperature by changing the pulse width.

The bias circuit unit may include: a first current generating unit that generates a first current increasing with an increase in temperature; and a second current generating unit that generates a second current decreasing with an increase in temperature, and may generate the bias current by adding the minus current of the second current to the first current.

The bias circuit unit may output the reference voltage on the basis of a reference current generated by adding up the first current and the second current.

The temperature sensor may further includes a voltage comparing unit that outputs a high value to the pulse generating unit, when the voltage of the capacitor is higher than the reference voltage, by comparing the voltage of the capacitor with the reference voltage, in which the pulse generating unit may output the pulse, when receiving the high value.

According to another embodiment of the present invention, a that measures a temperature by means of a temperature sensor, includes: outputting a bias current increasing with an increase in temperature; charging a capacitor with the bias current and discharging the capacitor for a discharge time; adjusting the frequency change degree of the capacitor to the bias current by changing the discharge time; and counting and outputting, as a digital value, the number of times of discharging the capacitor for a predetermined time.

The outputting of a bias current may generate the bias current by subtracting a second current decreasing with an increase in temperature from a first current increasing with an increase in temperature.

The discharging of a capacitor may generate a pulse when the voltage of the capacitor is higher than a reference voltage, and discharges the capacitor for the discharge time corresponding to the pulse width of the pulse.

The adjusting of the frequency change degree of the capacitor may increase the discharge time by delaying an inverter generating the pulse.

The adjusting the frequency change degree of the capacitor may control the discharge time by adjusting the amount of a current flowing through the inverter.

The outputting as a digital value may count and output the number of pulses generated for a predetermined time.

The adjusting of the frequency change degree of the capacitor may change the discharge time while monitoring whether the relationship of the frequency of the capacitor to a temperature becomes linear.

The method may further include calculating a temperature corresponding to the digital value, in which the calculating of a temperature may acquire the proportional relationship between a temperature and a digital value by measuring a first reference digital value proportioned to a first temperature and a second reference digital value proportioned to a second temperature, and may calculate a temperature that the digital value corresponds to between the first temperature and the second temperature on the basis of the proportional relationship.

According to an exemplary embodiment of the present invention, it is possible to reduce the amount of power consumed by a temperature sensor and increase accuracy of digital output by improving linearity.

### BRIEF DESCRIPTION OF THE DRAWINGS

FIG. 1 is a block diagram of a temperature sensor according to an exemplary embodiment of the present invention.

FIG. 2 is a graph showing a capacitor voltage to time according to an exemplary embodiment of the present invention.

FIG. 3 is a block diagram of a bias circuit unit according to an exemplary embodiment of the present invention.

FIG. 4 is a circuit diagram of a PTAT current generating unit according to an exemplary embodiment of the present invention.

FIG. 5 is a circuit diagram of a CTAT current generating unit according to an exemplary embodiment of the present invention.

FIG. 6 is a block diagram of a pulse generating unit according to an exemplary embodiment of the present invention.

FIG. 7 is a graph showing frequency control to a current according to an exemplary embodiment of the present invention.

FIG. 8 is a diagram schematically showing linearity of a temperature sensor according to an exemplary embodiment of the present invention.

FIG. 9 is a flowchart illustrating a method of measuring temperature according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, throughout the specification, unless explicitly described to the contrary, the word “comprise” and variations such as “comprises” or “comprising”, will be understood to imply the inclusion of stated elements but not the exclusion of any other elements.

A temperature sensor according to an exemplary embodiment of the present invention is described with reference to the drawings.

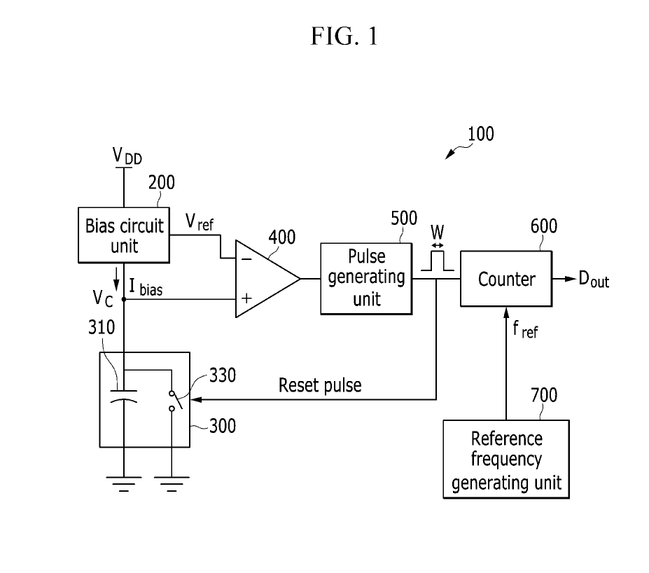

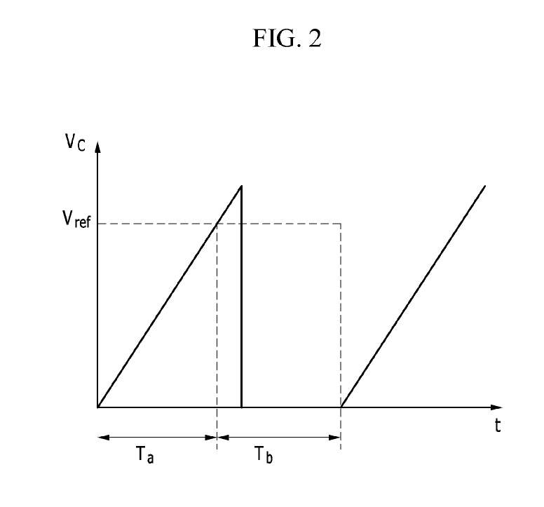

FIG. 1 is a block diagram of a temperature sensor according to an exemplary embodiment of the present invention and FIG. 2 is a graph showing a capacitor voltage to time according to an exemplary embodiment of the present invention.

Referring to FIG. 1, first, a temperature sensor 100 is a device for measuring a temperature which outputs a value related to a temperature as a digital value Dₒᵤₜ. The temperature sensor 100 includes a bias circuit unit 200, a capacitor voltage unit 300, a voltage comparing unit 400, a pulse generating unit 500, a counter 600, and a reference frequency generating unit 700. The bias circuit unit 200, the capacitor voltage unit 300, the voltage comparing unit 400, and the pulse generating unit 500 are relaxation oscillators that generate a non-sinusoidal wave such as a square wave and a sawtooth wave.

The bias circuit unit 200 outputs a bias current I_{bias} to the capacitor voltage unit 300. Further, the bias circuit unit 200 outputs a reference voltage V_{ref} to the voltage comparing unit 400. The bias current I_{bias} is a current increasing in accordance with a temperature and the reference voltage V_{ref} is a voltage irrelevant to a temperature.

The capacitor voltage unit 300 includes a capacitor 310 and a switch 330 connected to the capacitor in parallel. The capacitor voltage unit 300 is connected with the bias circuit unit 200 and receives the bias current I_{bias}. The capacitor voltage unit 300 is connected to the voltage comparing unit 400 and outputs a capacitor voltage V_{C} that is applied to the capacitor 310. When the switch 330 is open, the capacitor 310 is charged with the bias current I_{bias} flowing out of the bias circuit unit 200 bias current. Further, since the capacitor 310 is connected with the switch 330 in parallel, as the switch 330 closes, the capacitor 310 is discharged. The switch 330 operates in response to a control signal transmitted from the pulse generating unit 500, that is, a reset pulse.

The voltage comparing unit 400 compares the reference voltage V_{ref} outputted from the bias circuit unit 200 with the capacitor voltage V_{C} of the capacitor voltage unit 300. When the capacitor voltage V_{C} is higher than the reference voltage V_{ref}, the voltage comparing unit 400 outputs a high value, for example, 1. When the capacitor voltage V_{C} is lower than the reference voltage V_{ref}, the voltage comparing unit 400 outputs a low value, for example, 0.

The pulse generating unit 500 receives the high value from the voltage comparing unit 400 and generates a pulse with a predetermined pulse width w. The pulse generating unit 500 transmits the pulse to the capacitor voltage unit 300 and the counter 600. Further, the capacitor voltage unit 300 closes the switch 330 and resets the capacitor voltage V_{C} to 0, when receiving the pulse. Therefore, the pulse is also called a reset pulse for controlling the capacitor voltage V_{C} to be reset. The pulse generating unit 500 can change the discharge time of the capacitor by adjusting the pulse width. That is, the discharge time is a value related to the frequency f_{C} of the capacitor, such that the pulse generating unit 500 compensates for nonlinearity of the bias current I_{bias} by adjusting the degree of change in frequency of the capacitor to the bias current I_{bias}, by changing the pulse width.

The counter 600 counts the pulses transmitted from the pulse generating unit 500 for one cycle of the reference frequency f_{ref}. Further, the counter 600 outputs the number of pulses as a digital value Dₒᵤₜ. The reference frequency f_{ref} is transmitted to the reference frequency generating unit 700. The capacitor voltage V_{C} is increased by the bias current I_{bias} that increases with an increase in temperature. Therefore, the higher the temperature, the faster the capacitor voltage V_{C} reaches the reference voltage V_{ref}, such that the number of pulses generated by the pulse generating unit 500 for one cycle of the reference frequency f_{ref} increases. That is, the number of pulses is a value related to the cycle or the frequency of the capacitor 310, and the higher the temperature, the higher the frequency f_{C} of the capacitor 310, such that the digital value Dₒᵤₜ is a value proportioned to a temperature. Therefore, the proportional relationship between the digital value and the temperature is set by obtaining in advance digital values outputted at specific two temperatures. A temperature corresponding to the digital value Dₒᵤₜ outputted from the counter 600 is calculated on the basis of the proportional relationship between the digital value and the temperature.

As described above, the temperature sensor 100 can output a digital value using, not an analog-digital converter that consumes a large amount of power, but the counter 600.

Referring to FIG. 2, the capacitor 310 repeats being charged/discharged with a predetermined cycle T, charged with the bias current I_{bias} for a predetermined time and reset by the pulses from the pulse generating unit 500. When the capacitor voltage V_{C} is lower than the reference voltage V_{ref}, the capacitor 310 is charged, and when the capacitor voltage V_{C} is higher than the reference voltage V_{ref}, the capacitor 310 is discharged. The capacitor 310 is charged for a charge time Tₐ where the capacitor voltage V_{C} reaches the reference voltage V_{ref}, and may be further charged for comparator delay of the voltage comparing unit 400, even if the capacitor voltage is higher than the reference voltage V_{ref}. Further, the capacitor 310 can be discharged for the time corresponding to the pulse width of the pulse generating unit 500. Therefore, the cycle T of the capacitor 310 is a time obtained by adding the delay and discharge time T_{b} to the charge time Tₐ. The delay and discharge time T_{b} is the sum of the comparator delay and the pulse width w of the voltage comparing unit 400. The capacitor frequency f_{C} is as Equation 1. The charge time Tₐ is as Equation 2.

$$\begin{matrix}{f}_{C} = \frac{1}{{T}_{a} + {T}_{b}} & ( Equation 1 ) \\ {T}_{a} = \frac{C \cdot {V}_{ref}}{{I}_{bias}} & ( Equation 2 )\end{matrix}$$

The capacitor voltage V_{C} increases in proportion to the bias current I_{bias}, and the higher the temperature, the more the bias current I_{bias} flows. Therefore, the higher the temperature, the faster the capacitor voltage V_{C} reaches the reference voltage V_{ref}, and the frequency f_{C} increases. That is, the higher the temperature, the larger the number of pulses generated by the pulse generating unit 500. Therefore, the counter 600 can find the temperature on the basis of the number of pulses generated by the pulse generating unit 500. Further, the pulse generating unit 500 can adjust the linearity in change of the capacitor frequency f_{C} according to a temperature, by adjusting the delay and discharge time T_{b}.

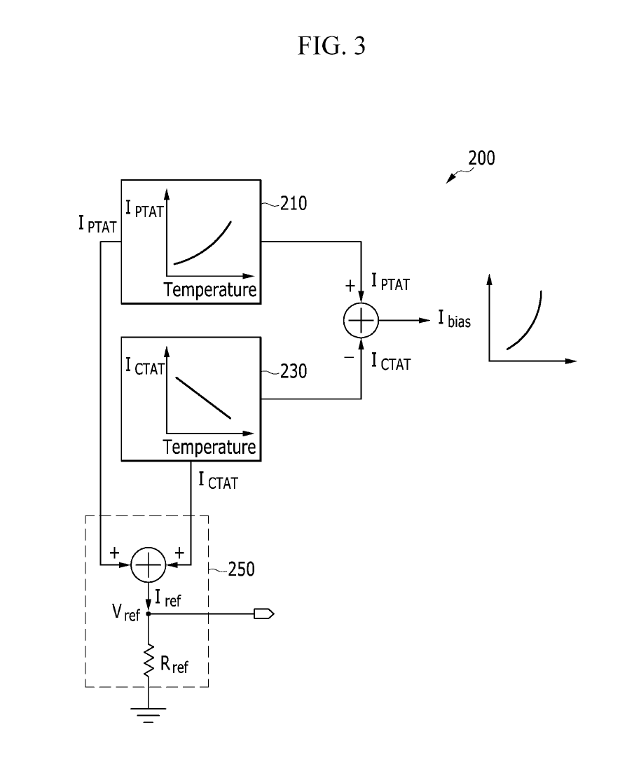

FIG. 3 is a block diagram of a bias circuit unit according to an exemplary embodiment of the present invention.

Referring to FIG. 3, the bias circuit unit 200 outputs a bias current I_{bias} to the capacitor voltage unit 300. Further, the bias circuit unit 200 outputs a reference voltage V_{ref} to the voltage comparing unit 400. To this end, the bias circuit unit 200 uses a PTAT (Proportional to Absolute Temperature) current I_{PTAT} and a CTAT (Complementary to Absolute Temperature) current I_{CTAT}.

The bias circuit unit 200 includes a PTAT current generating unit 210 that generates the current I_{PTAT}, a CTAT current generating unit 230 that generates the current I_{CTAT}, and a reference voltage generating unit 250 that generates the reference voltage V_{ref}. The PTAT current generating unit 210 outputs the PTAT current I_{PTAT}. The CTATcurrent generating unit 230 generates the CTAT current I_{CTAT}. The reference voltage generating unit 250 is implemented by a resistor R_{ref}. That is, the reference voltage generating unit 250 outputs the voltage applied to the resistor R_{ref} as a reference voltage. The current I_{PTAT} and the current I_{CTAT} may show nonlinear features.

The bias circuit unit 200 makes a reference current, which is obtained by adding up the current I_{PTAT} and the current I_{CTAT}, flow to the reference voltage generating unit 250. Since the reference voltage is the sum of the current increasing with an increase in temperature and the current I_{CTAT} decreasing with an increase in temperature, it is consequently a current irrelevant to a temperature. Therefore, the voltage V_{ref} applied to the resistor R_{ref} is a voltage irrelevant to a temperature.

The bias circuit unit 200 generates the bias current I_{bias} by adding up the current I_{PTAT} and the minus current −I_{CTAT} of the current I_{CTAT}. That is, the bias circuit unit 200 makes the bias current I_{bias}, which is obtained by subtracting the current I_{CTAT} from the current_{PTAT}, flow to the capacitor voltage unit 300.

The bias current I_{bias} is a value obtained by subtracting the current I_{CTAT} decreasing with an increase in temperature from the current I_{PTAT} increasing with an increase in temperature. As a result, the higher the temperature, the more the bias current I_{bias} flows than the current I_{PTAT},

That is, the bias current I_{bias} is a current that sensitively reacts to a change in temperature.

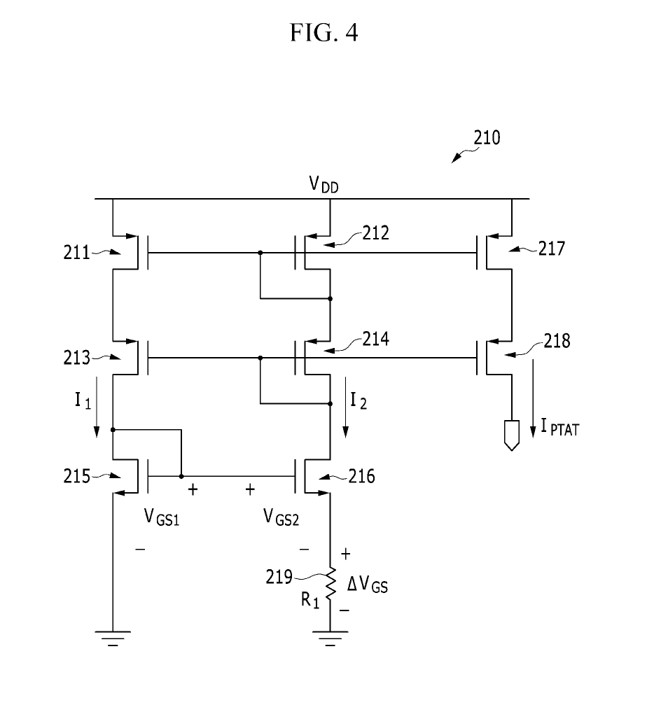

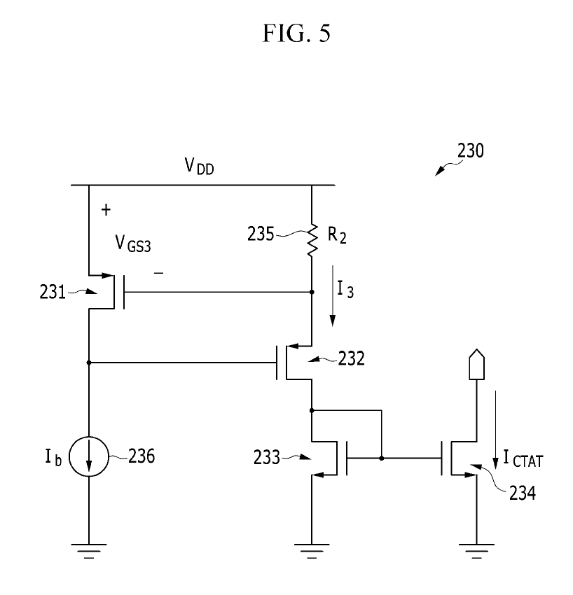

FIG. 4 is a circuit diagram of a PTAT current generating unit according to an exemplary embodiment of the present invention and FIG. 5 is a circuit diagram of a CTAT current generating unit according to an exemplary embodiment of the present invention.

Referring to FIG. 4 first, the PTAT current generating unit 210 is a circuit that generates a current I_{PTAT} increasing with an increase in temperature and may be designed in various ways on the basis of a plurality of transistors. For example, the PTAT current generating unit 210 includes a plurality of transistor 211, 212, 213, 214, 215, 215, 217, and 218 and a resistor R₁ (219).

The transistors 211-214 are PMOS transistors that implement a current mirror and outputs currents I₁ and I₂ by the current mirror. A pair of transistors 211 and 213 is connected in series, a pair of transistors 212 and 214 is connected in series, and the pair of transistors 211 and 213 and the pair of transistors 212 and 214 constitute the current mirror by connecting corresponding gates. The current I₁ outputted from the drain of the transistor 214 is inputted to the drain of the NMOS transistor 215. The current I₂ outputted from the drain of the transistor 214 is inputted to the drain of the NMOS transistor 216. The current I₁ and the current I₂ by the current mirror are the same.

The relationship between a gate-source voltage V_{GS} and a drain-source current I_{DS}, when a transistor operates at subthreshold, is as Equation 3.

$${I}_{DS} = {KI}_{0} exp ( \frac{{V}_{GS} - {V}_{TH}}{η {V}_{T}} ) , \\ {I}_{0} = μ {C}_{ox} ( η - 1 ) \cdot {V}_{T}^{2} \qquad ( Equation 3 )$$

In equation 3, K is a constant (=WL) relating to the size of the transistor, μ is carrier mobility, V_{T} is a temperature voltage (thermal voltage), V_{TH} is a threshold voltage, and η is a subthreshold slope factor shown at subthreshold. Further, V_{DS} is a drain-source voltage.

Since the current I₁ and the current I₂ are the same, they can be expressed as in Equation 4. Equation 4 is arranged as Equation 5.

$$\begin{matrix}{K}_{1} {I}_{0} exp ( \frac{{V}_{GS 1} - {V}_{TH}}{η {V}_{T}} ) = {K}_{2} {I}_{0} exp ( \frac{{V}_{GS 2} - {V}_{TH}}{η {V}_{T}} ) & ( Equation 4 ) \\ exp ( \frac{{V}_{GS 1} - {V}_{TH}}{η {V}_{T}} - \frac{{V}_{GS 2} - {V}_{TH}}{η {V}_{T}} ) = \frac{{K}_{2}}{{K}_{1}} & ( Equation 5 )\end{matrix}$$

The voltage applied to the resistor is the difference between the gate-source voltage V_{GS1} of the transistor 215 and the gate-source voltage V_{GS2} of the transistor 216 and can be expressed as in Equation 6.

$$∴ Δ {V}_{GS} = {V}_{GS 1} - {V}_{GS 2} = η {V}_{T} \cdot ln ( \frac{{K}_{2}}{{K}_{1}} ) \qquad ( Equation 6 )$$

The transistors 217 and 218 are PMOS transistors connected to the gates of the transistors 212 and 214, respectively, and duplicated in a current mirror shape, thereby outputting a current I_{PTAT}. The current I_{PTAT} is as in Equation 7.

$${I}_{PTAT} = \frac{Δ {V}_{GS}}{{R}_{1}} \qquad ( Equation 7 )$$

Referring to Equation 7, the current I_{PTAT} is influenced by the voltage applied to the resistor R₁ (219), as in Equation 7. The current I_{PTAT} shows a PTAT feature due to ΔV_{GS}. However, the resistor R₁ (219) may have a CTAT feature due to the temperature property of the material used for the resistor. Therefore, since the resistance decreases with an increase in temperature, the current I_{PTAT} shows nonlinearity, even if the temperature-current conversion of ΔV_{GS} is linear. That is, as shown in the graph of the current I_{PTAT}, in FIG. 3, the inclination of conversion shows a tendency to increase with an increase in temperature.

As described above, the PTAT current generating unit 210 generates a current I_{PTAT} that nonlinearly increases with an increase in temperature.

Next, referring to FIG. 5, the CTAT current generating unit 230 is a circuit that generates a current I_{CTAT} decreasing with an increase in temperature and may be designed in various ways on the basis of a plurality of transistors. For example, the CTAT current generating unit 230, as shown in FIG. 3, may be designed with transistors 231, 232, 233, and 234, a resistor R₂ (235), and a current source 236. The current, as in Equation 8, is determined by the gate-source voltage V_{GS3} and the resistor DELETEDTEXTS (235). Since the gate-source voltage V_{GS} of the transistor decreases with an increase in temperature, as in Equation 9, so the current I_{CTAT} has a CTAT feature.

$$\begin{matrix}{I}_{CTAT} = \frac{{V}_{GS 3}}{{R}_{2}} & ( Equation 8 ) \\ {V}_{GS} \approx {V}_{GS} ( {T}_{o} ) + {K}_{S} ( \frac{T}{{T}_{o}} - 1 ) = {V}_{GS} ( {T}_{o} ) \cdot ( 1 + {K}_{C} Δ T ) \\ {K}_{C} < 0 & ( Equation 9 )\end{matrix}$$

The current I_{CTAT} can be an expression to a temperature, as in Equation 10.

$${I}_{CTAT} \approx \frac{{V}_{GS } ( {T}_{o} )}{{R}_{2} ( {T}_{o} )} \cdot ( 1 - ( {K}_{C} - {K}_{R} ) Δ T - ( {K}_{C} {K}_{R} - {K}_{R}^{2} ) Δ {T}^{2} + … ) \qquad ( Equation 10 )$$

The first order term of ΔT shows the slope to the temperature in CTAT conversion and the second order term shows nonlinearity. The current I_{CTAT} has a temperature-current change that is more linear than the current I_{PTAT}, because the CTAT feature of the resistor and the CTAT feature of V_{GS} are offset.

However, the current I_{CTAT} is difficult to use to sense a change in temperature by itself, because the sensitivity of a voltage change to the temperature of V_{GS} is not large. The sensitivity may be the coefficient of the first order term of ΔT, that is, K_{C}-K_{R}. Therefore, the current I_{CTAT} is used up to now to sense a temperature, even if there is nonlinearity.

Referring to FIG. 3 again, the temperature sensor 100 senses a temperature, using not only the current I_{PTAT}, but the bias current I_{bias} that is the difference between the current I_{PTAT} and the current I_{CTAT}. The bias current I_{bias} is a current with a smaller offset current and a larger slope than the current I_{PTAT}, it is possible to increase the sensitivity of a voltage change to a temperature.

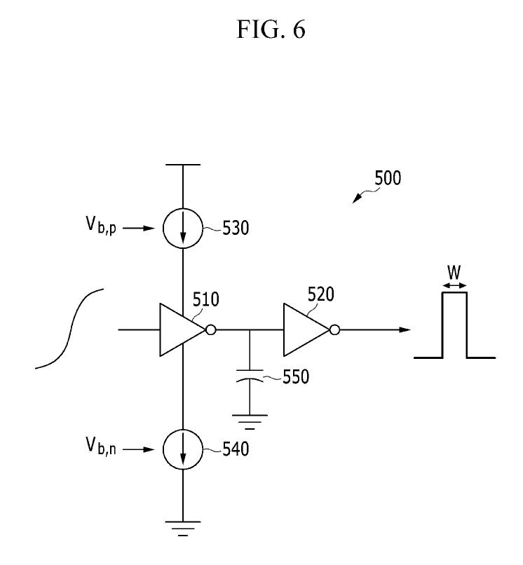

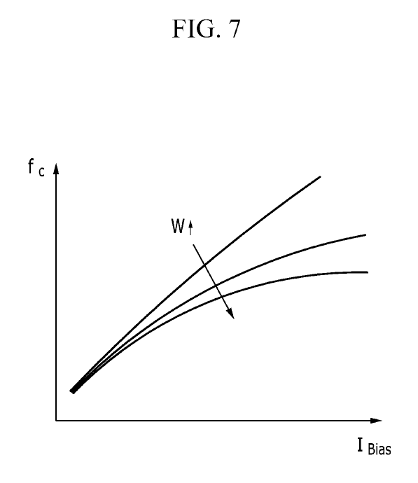

FIG. 6 is a block diagram of a pulse generating unit according to an exemplary embodiment of the present invention and FIG. 7 is a graph showing frequency control to a current according to an exemplary embodiment of the present invention.

Referring to FIG. 6 first, the pulse generating unit 500 receives a high value from the voltage comparing unit 400 and generates a pulse. The pulse generating unit 500 includes inverters 510 and 520, one or more control units 530 and 540, which control current of the inverters, and a capacitor 550.

The width of the pulse to be outputted from the pulse generating unit 500 depends on inverter delay by the inverters. The inverter delay depends on the capacitance of the capacitor 550 and the magnitude of the current flowing through it. The larger the capacitance and the less the current flows, the larger the inverter delay. Therefore, the pulse generating unit 500 changes the pulse width w by adjusting the amount of the current flowing to the inverter 510, by changing the capacitance of controlling the control units 530 and 540.

Assuming that the inverters 510 and 520, the one or more control units 530 and 540 controlling the inverter current, and the capacitor 550 are one inverter set, the pulse generating unit 500 can adjust the inverter delay within a wide range by connecting a plurality of inverter sets in series.

Referring to the FIG. 7 and Equation 1, the capacitor frequency f_{C} to the bias current I_{bias} smoothly increases, as the bias current I_{bias} increases.

As the pulse generating unit 500 changes the pulse width w, the capacitor frequency f_{C} to the bias current I_{bias} changes. As the pulse width w increases, the charge/discharge cycle of the capacitor 310 is increased, such that the frequency decreases. Therefore, as the pulse width w increases, the capacitor frequency f_{C} to the bias current I_{bias} less changes. On this features, the pulse generating unit 500 offsets the nonlinearity of the bias current I_{bias} to a temperature by adjusting the degree of change of the capacitor frequency f_{C} to the bias current I_{bias}.

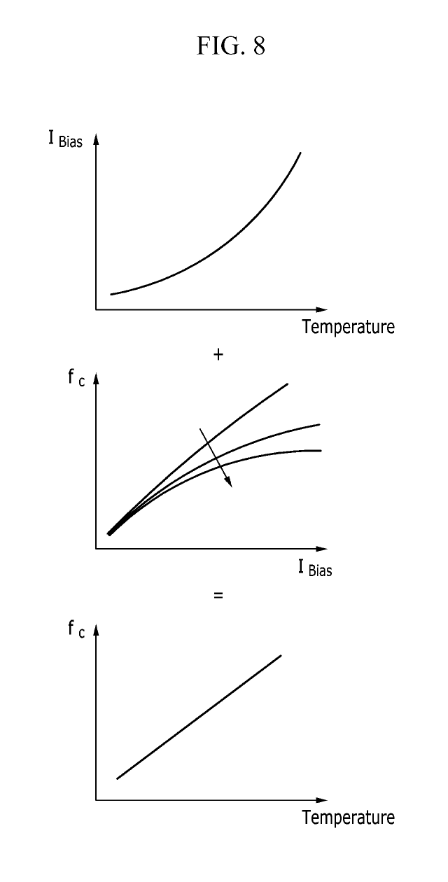

FIG. 8 is a diagram schematically showing linearity of a temperature sensor according to an exemplary embodiment of the present invention.

Referring to FIG. 8, the bias control unit 200 outputs a bias current I_{bias} increasing with an increase in temperature and the bias current I_{bias} nonlinearly increases to a temperature. Further, the capacitor frequency f_{C} nonlinearly increases to the bias current I_{bias}. However, the larger the bias current I_{bias}, the more the slope of the graph of the capacitor frequency f_{C} to the bias current I_{bias} becomes smooth, but the higher the temperature, the more the slope of the graph of the bias current I_{bias} to the temperature becomes rapid.

Therefore, when the capacitor frequency f_{C} to the bias current I_{bias} is changed by changing the pulse width w, the nonlinearity due to the bias current I_{bias} is compensated. To this end, a user selects a pulse width that can compensate for the nonlinearity of the bias current I_{bias} as much as possible, by checking the frequency output and changing the pulse width w of the pulse generating unit 500 when measuring a temperature.

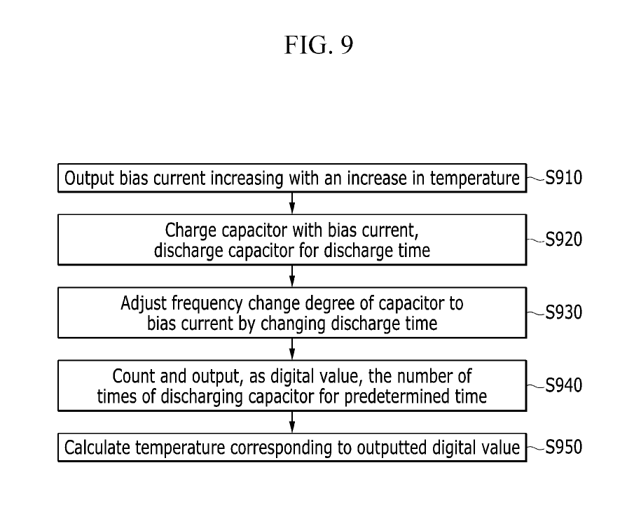

FIG. 9 is a flowchart illustrating a method of measuring temperature according to an exemplary embodiment of the present invention.

Referring to FIG. 9, the temperature sensor 100 outputs a bias current I_{bias}, when a temperature increases (S910). The bias current I_{bias}, a value obtained by subtracting a current I_{CTAT} decreasing with an increase in temperature from a current I_{PTAT} increasing with an increase in temperature, sensitively reacts to a change in temperature.

The temperature sensor 100 charges the capacitor 310 with the bias current I_{bias} and discharges the capacitor 310 for a discharge time (S920). The temperature sensor 100 repeats charging and discharging on the basis of the result of comparing the capacitor voltage V_{C} with the reference voltage V_{ref}. The temperature sensor 100 uses the features of a relaxation oscillator, then it generates a pulse when the capacitor voltage V_{C} is higher than the reference voltage V_{ref}, and discharges the capacitor when the pulse is generated. That is, the discharge time is the pulse width w.

The temperature sensor 100 adjusts the degree of frequency change of the capacitor to the bias current I_{bias} by changing the discharge time (S930). The temperature sensor 100 can increase the discharge time of the capacitor 310 by increasing the pulse width, by delaying the inverter 510 that generates a pulse. In this operation, the temperature sensor 100 can delay the inverter 510 by adjusting the amount of current flowing through the inverter 510. As described with reference to FIGS. 6 to 8, the temperature sensor 100 changes the discharge time, that is, the pulse width w to compensate for the nonlinearity of the bias current I_{bias} while monitoring the capacitor frequency f_{C}.

The temperature sensor 100 counts the number of times of discharging the capacitor for a predetermined time and outputs the number as a digital value (S940). The number of times of discharging is the same as the number of pulses generated by the pulse generating unit 500. That is, the temperature sensor 100 counts and outputs the number of pulses generated by the pulse generating unit 500 and can find a temperature from the value.

The temperature sensor 100 calculates a temperature corresponding to the outputted digital value (S950). The temperature sensor 100 acquires a proportional relationship between a temperature and a distal value by measuring a first reference digital value proportioned to a first temperature and a second reference digital value proportioned to a second temperature. Further, the temperature sensor 100 calculates a temperature that the current digital value corresponds to between the first temperature and the second temperature, on the basis of the proportional relationship. That is, the digital value is the number of pulses and the number of pulses is associated with the capacitor frequency f_{C}. Further, the capacitor frequency is associated with the bias current I_{bias} and the bias current I_{bias} is influenced by a temperature. Therefore, the temperature sensor 100 can find a temperature from the digital value.

As described above, the temperature sensor 100 can operate with low power by using not an analog-digital converter that consumes a large amount of power, but the counter 600. Further, the temperature sensor 100 can improve linearity of temperature-frequency conversion by compensating the nonlinearity of a current to a temperature on the basis of frequency control.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A temperature sensor that senses a temperature on the basis of a relaxation oscillator, the temperature sensor comprising:
a bias circuit unit that outputs a bias current increasing with an increase in temperature;
a capacitor voltage unit that charges a capacitor with the bias current and discharges the current when receiving a control signal;
a pulse generating unit that outputs a pulse when the voltage of the capacitor is higher than a reference voltage, changes the pulse width of the pulse, and transmits the pulse corresponding to the control signal to the capacitor voltage unit; and
a counter unit that counts and outputs, as a digital value, the number of pulses outputted from the pulse generating unit, on the basis of a reference frequency.

2. The temperature sensor of claim 1, wherein the pulse generating unit includes at least one inverter and a capacitor connected with the inverter in series, and changes the pulse width by adjusting the amount of a current flowing through the inverter.

3. The temperature sensor of claim 1, wherein the pulse generating unit compensates for nonlinearity of the bias current to a temperature by changing the pulse width.

4. The temperature sensor of claim 1, wherein
the bias circuit unit includes:
a first current generating unit that generates a first current increasing with an increase in temperature; and
a second current generating unit that generates a second current decreasing with an increase in temperature, and
generates the bias current by adding the minus current of the second current to the first current.

5. The temperature sensor of claim 1, wherein the bias circuit unit outputs the reference voltage on the basis of a reference current generated by adding up the first current and the second current.

6. The temperature sensor of claim 1, further comprising:
a voltage comparing unit that outputs a high value to the pulse generating unit, when the voltage of the capacitor is higher than the reference voltage, by comparing the voltage of the capacitor with the reference voltage,
wherein the pulse generating unit outputs the pulse, when receiving the high value.

7. A method that measures a temperature by means of a temperature sensor, the method comprising:
outputting a bias current increasing with an increase in temperature;
charging a capacitor with the bias current and discharging the capacitor for a discharge time;
adjusting the frequency change degree of the capacitor to the bias current by changing the discharge time; and
counting and outputting, as a digital value, the number of times of discharging the capacitor for a predetermined time.

8. The method of claim 7, wherein the outputting of a bias current generates the bias current by subtracting a second current decreasing with an increase in temperature from a first current increasing with an increase in temperature.

9. The method of claim 7, wherein the discharging of a capacitor generates a pulse when the voltage of the capacitor is higher than a reference voltage, and discharges the capacitor for the discharge time corresponding to the pulse width of the pulse.

10. The method of claim 9, wherein the adjusting of the frequency change degree of the capacitor increases the discharge time by delaying an inverter generating the pulse.

11. The method of claim 10, wherein the adjusting the frequency change degree of the capacitor controls the discharge time by adjusting the amount of a current flowing through the inverter.

12. The method of claim 9, wherein the outputting as a digital value counts and outputs the number of pulses generated for a predetermined time.

13. The method of claim 7, wherein the adjusting of the frequency change degree of the capacitor changes the discharge time while monitoring whether the relationship of the frequency of the capacitor to a temperature becomes linear.

14. The method of claim 7, further comprising:
calculating a temperature corresponding to the digital value,
wherein the calculating of a temperature
acquires the proportional relationship between a temperature and a digital value by measuring a first reference digital value proportioned to a first temperature and a second reference digital value proportioned to a second temperature, and calculates a temperature that the digital value corresponds to between the first temperature and the second temperature on the basis of the proportional relationship.
